(19) United States
(12) Patent Application Publication
(10) Pub. No.: US 2017/0099325 A1
(43) Pub. Date: Apr. 6, 2017

(54) Method and System for Establishing Real-Time Audio Connections

(71) Applicant: LINEAPP GMBH, WIEN (AT)

(72) Inventors: Lukas STEINER, FEISTRITZ/DRAU (AT); LUIS MARTIN NELL, WIEN (AT); ALEXANDER KRÄNKL, WIEN (AT)

(73) Assignee: LINEAPP GMBH, WIEN (AT)

(21) Appl. No.: 15/314,770

(22) PCT Filed: May 29, 2015
(86) PCT No.: PCT/EP2015/061950

§ 371 Date: Nov. 29, 2016

(30) Foreign Application Priority Data
May 30, 2014 (EP) 14170617.6

(51) Int. Cl. H04L 29/06

(52) U.S. Cl. CPC H04L 65/1069; H04L 65/1059; H04L 65/4061; H04W 4/08

(57) ABSTRACT

A method for providing selectable real-time audio connections between an executing communication unit (1) and a plurality of further communication units (2) in a communication group (3). The executing communication unit (1) establishes a connection to a data network, determines further communication units (2), forms a communication group (3) that comprises the executing communication unit (1) and at least one further communication unit (2), defines an address assignment for an audio channel to the at least one remote communication unit, receives a user input for activation of the real-time audio transmission by selecting an activation element (4), and opens the audio channel.

The invention relates to a method for providing selectable real-time audio connections in which the audio connection has a delay of less than 40 ms, preferably less than 20 ms between an executing communication unit and a plurality of further communication units in a communication group, wherein at least the executing communication unit provides a plurality of activation elements that may be activated by user selection for selective activation of real-time audio connections between the executing communication unit and at least one additional communication unit, which is assigned to the respective activation elements. The invention further relates to a real-time audio communication system with a plurality of communication units which each have at least one communication interface for connection to the data network and an audio output.

The above method is implemented in the prior art of intercom systems that are used for example in event organization and in the organization of sporting events. Intercom systems are increasingly also used in film production and make the work of directors and production teams much easier. Because of the high costs for rental and construction of professional intercom systems, their use in smaller productions or in the hobby field presently is scarcely possible. The reason for this is that technical equipment is provided only by a few suppliers whose core business is above all the rental of systems and offering of services for large events. The holders of smaller events usually cannot afford these systems. This is because the voice terminals have to be connected to one another by fiberglass cables and frequently, kilometer-long cable links have to be laid, which can be done only by qualified personnel with a great time expenditure. Without this expenditure however it would not be possible to achieve a qualitatively high-value intercom system with selectable real-time audio connection.

US 2013/0109425 discloses a method and systems for group communication between different devices via a mobile telephone communication net, wherein a push-to-talk functionality is described, in which exactly one active device can speak, while the other devices listen passively.

US 2007/0054687 A1 discloses a method for dynamic provision and management of communication groups for push-to-talk communication between mobile devices that operate in a mobile telephone net.

It is the goal of the present invention to provide a method and a system of the above-named type that avoids the disadvantages of the prior art. In particular, the costs, technical expenditure, and time required for preparation of an intercom system are so greatly reduced that these applications are affordable not only for major events but also for small events, projects, and enterprises or even for private use. The above-named method according to the invention achieves this and other goals in that the executing communication unit performs the following steps:

provision of a connection to a data network

acquisition of additional communication units that are in the range of the data network and that are capable of establishing a real-time audio connection;

formation of a communication group that comprises the executing communication unit and at least one of the acquired further communication units;

determination of an address assignment for an audio channel via the data network to the at least one remote communication unit;

provision of an activation element at a user interface of the executing communication unit that is assigned to a remote communication unit;

reception of user input for activation of the audio channel by selection of the activation element; and

opening of the audio channel via the data network using the address assignment and keeping the audio channel open as long as the activation element is activated.

The method according to the invention makes possible in an advantageous manner the flexible setup of an intercom system via a data network, for example an available WLAN or one provided especially for the specific purpose. The method is especially simple as the entire communication is functional without the interposition of a server. In this way also there is a very high error and interference tolerance.

Any network arrangement that permits communication between terminal devices can be considered a “data net.” In particular, the data network can also be formed from a combination of different networks. For example, communication can be with specific communication units via a short range radio network as for example a Bluetooth connection, while the data transmission to further communication units can be via a WLAN network, of a consolidation of a number of WLAN and/or LAN and/or WAN networks. Furthermore, a data net can also comprise a connection via the Internet, wherein in this case the audio communication system can extend over several (worldwide) distributed locations.

In connection with this description, a “real-time audio connection” may be seen as an audio connection whose time delay during transmission is so brief that it is scarcely or not at all perceived by the user. An audio connection can in particular be used for the transmission of speech, wherein it is possible with a real-time audio connection to conduct a conversation between two remote users in real time.

In connection with the present description, the term “audio channel” designates a transmission link over which an audio signal that is picked up by one microphone at one side of the channel is output substantially delay-free via an output, in particular a loudspeaker or headset at the other end of the channel. An audio channel can be open, wherein audio signals are transmitted, or closed, wherein no audio signals are transmitted.

The audio channel works “substantially delay-free.” This means that only physically and technically induced delays occur. In connection with speech transmission an audio channel at any rate can be viewed as substantially delay-free when in advantageous manner the audio connection has a delay of less than 40 ms and preferably less than 20 ms. A delay of this magnitude in speech communication is scarcely or not at all perceived by the users so that two interlocutors can speak with one another as if in a direct meeting. For many usage cases that can mean for example that speech has to be transmitted “lip-synchronous.” As soon as a user notices that the speech signal no longer conforms to the lip movement the delay becomes perceivable to him. At the point when the audio signal is so strongly displaced from mouth movements that the user no longer sees a connection, the delay can no longer be viewed as “substantially delay-free.”

As with all technical features that are assessed with reference to human perception, in the perception of transmission delays too there are large differences between individuals. It could be that for example a director or a musician can distinctly perceive a delay of just 10 or 8 ms, view even this short delay as unusable for directing or performing (for example in studio recordings or live performances). Other individuals without a specially educated and trained ear will notice delays only if they are much greater.

Thus even if the feature “substantially delay-free” can be assessed with reference to a measure that is based on the perception of a user, tests carried out in connection with intercom systems indicate that there is a limit for the delay after which communication is found by most users to be qualitatively inadequate or unusable. Starting at that point for example it becomes impossible to reasonably synchronize processes (for example in theater performances if the curtain is supposed to be opened or closed on command or if lighting effects are to be coordinated). This general limits lies at around between 30 and a maximum of 40 ms and for a generally usable intercom system the technically available means must be used in order to bring the delay below this value.

In order to establish real-time audio connections with the method according to the invention in which the delay is less than 40 ms and preferably less than 20 ms, steps can be taken for technical optimization to minimize the onset of delays during transmission. These steps of technical optimization can in particular comprise one or more of the following measures:

minimization of buffer times,

minimization of data packet length,

avoidance or minimization of connections via third-party wide-area networks or via the Internet,

avoidance or minimization of interposition of servers, in particular Internet servers,

prioritizing marking of data packets for real-time audio connections (for example by means of so-called “real-time-flags”),

use of transmission units (for example routers, switches, and/or servers) that are capable of prioritizing such marked data packets,

minimization of transmission units between senders and recipients by targeted selection of the transmission path,

use of low-delay methods for processing of audio data packets and/or low-delay codecs,

use of low-delay error correction mechanisms such as for example Packet Loss Concealment (PLC), Forward Error Correction (FEC), Adaptive Playout and/or Adaptive Jitterbuffering.

adaptive adjustment of the methods for processing of audio /data packet and or codecs for example with allowance for an obtained value of an anticipated packet loss,

avoidance of hardware-induced transmission errors for example by using high-value transmission cable or radio links,

minimization of latency times of AD and/or DA converters.

In particular, the value of the audio length contained in a single audio data packet and the buffer times in the transmission link also directly affect the total delay even with otherwise optimal transmission conditions. Solely by a minimization of the data packet lengths and minimization of buffer times, connection quality can be achieved (assuming the corresponding hardware environment) that corresponds to the specifications of a real-time audio connection.

These steps for technical optimization can mutually interact. For example, the reduction in data packet length can impair certain error correction mechanisms. In practice for example it has turned out that with a packet data size of around 2.5 ms (referred to the audio time) the usual error correction algorithms can fail. Such a minimal value (that also allows a minimal total delay) thus can be used only with very high-value transmission links (with low packet loss). If a higher packet loss occurs, the selected packet data size must accordingly be increased, for example with a value of around 10 ms in order to increase the effectiveness of the error correction, wherein this value still makes it possible to achieve a value for the total delay time that corresponds to the requirements of a real-time audio connection.

For certain hardware or software configurations it is sometimes not possible to achieve such good values because owing to the hardware or software-induced restrictions, it is not possible to go below certain delay times. In these cases, the audio communication system can also be operated after a fashion with poorer values satisfactorily, for example with a delay of 300-400 ms, but there can be noticeable quality losses, so that the method always has to be implemented so that the delay of the audio connection is always as short as possible.

In order to make possible a true push-to-talk functionality, it is advantageous if the opening of the audio can now occur directly upon activation of the real-time audio transmission. “Directly” means in this contact that the delay between the selection of the activation element and the opening of the audio channel by the user is scarcely or not at all perceived. This is possible according to the invention as the address assignment for the audio channel is already established and thus upon activation no time-consuming connection setup needs to take place.

Here the address assignment can advantageously contain exclusively assigned ports. In this way (audio-) data can be transmitted to the further communication unit (or back from the latter) without a connection setup having to occur. Each data channel thus remains according to its address, even when there is no audio transmission at all. Each communication unit knows the open ports of all other communication units of the communication group, so that data traffic can occur directly, bypassing the intervening connection protocols. This makes communication possible even if the user interface no longer reacts or crashes because of program errors, or the communication channel itself becomes unstable.

Since data networks do not guarantee the arrival of a packet (or the correct sequence of arrival of packets), potentially unstable networks can also be compensated by means of techniques that are known per se. This comprises for example the numbering of individual data packets in order to be able subsequently to process them in a correctly sorted manner. Existing applications are in OSI Layer 4. Thus the higher the rate of missing or erroneously queued packets, the more unstable the network and thus the more frequent (longer) the temporary storage. This technique for dynamic compensation of unstable networks is also called “adaptive buffering,” wherein this occurs to the detriment of delay freedom. When the network recovers from an unstable situation, the operation of the buffer (also called the jitterbuffer) also decreases and substantially delay-free audio playback can occur.

In a further advantageous embodiment of the method according to the invention, activation elements can be activated for various activation types, comprising any desired combination of an active, passive, one-way, and/or two-way communication. In this way the method can be flexibly used for many different areas of use. In this regard “active” means that audio signals are transmitted at least by the home device to a remote device; “passive” means that audio signals are only transmitted from the remote device to the home device; “two-way” means signal transmission in both directions. In an especially advantageous manner, the current activation type and/or the current status of the communication connection can be indicated by different design of the activation element. In this way current settings and system states as well as error functions can be directly recognized. The design of the activation elements here can in particular differ with respect to color, pattern, shape, arrangement of activation element, labeling, display of symbols, display of images on the activation element, or a combination of these measures. The activation element can for example also be communicated by an avatar or an image of the communication partner or group with which communication is carried out.

In an advantageous manner, all of the communication units obtained in the data network can be automatically combined into the communication group. For smaller communication groups (for example fewer than 6 persons) this can constitute a preferred approach, as no user actions are necessary for formation of the communication group. The steps necessary for the user to set up an audio communication network in this case are limited to starting the app. At that point all communication units in the same network (for example in the same WLAN) are scanned and added to the communication group. Further configuration steps are not necessary. It goes without saying that as needed further configurations can subsequently be offered via menu functions.

In a further advantageous embodiment of the method according to the invention, furthermore the step of formation of a communication group can include defining of the subgroups and or the assignment of authorizations. The communication with all communication units of a subgroup can then be jointly activated for example with a single activation element. In connection with the issuance of authorizations, complex organizational structures can be reproduced. In practice for example security personnel of an event can be combined into their own subgroup, wherein each subgroup member has authorization to activate a voice channel to a leader of the subgroup or to the entire subgroup; activation of voice channels with one another or with some other subgroup can be prohibited. The group leader again can be provided with more comprehensive authorizations, both with respect to individual persons from the subgroup and with respect to other units outside of the group, to open channels.

In a further advantageous embodiment of the invention, a communication connection can also be activated for the transmission of data. On the one hand in this way documents but also for example current images or video images can be sent and on the other for example polling, confirmation etc. can be implemented “at the push of a button.”

Advantageously, the audio transmission can have voice activation. For special applications the voice activation can augment the activation element or even replace it. In addition, the audio transmission can be voice-controlled over an open audio channel. If necessary, a filter function can block out background noises and the like. In this way the voice activation can also be used in loud surroundings such as stadiums for example.

In a preferred embodiment of the invention, the executing and or the remote communication units can each be a stationary or a mobile user device and in particular they can be selected from Smartphones, mobile phones, radio devices, radio headsets, tablet PCs, personal computers, radio receivers capable of audio communication, and devices specifically designed for the method or the like. The method can thus be operated platform-independently, wherein not only the manufacturer-dependent equipment but also for example the personal devices of the participants can be used to set up the communication net. Thus various devices can also be involved in setup of the communication net.

Advantageously the audio transmission can be encrypted. In this way true end-to-end encryption can be implemented very effectively between the communication units. Such end-to-end encryption can be based on existing and well-tested techniques of encryption in IP-based networks. Here operations can be at various levels of the OSI layer model. Chiefly the Layer 4 is offered with the so-called stream-ciphers based on the encryption standard AES, Salsa20, or DTLS. Here specific keys are exchanged before the first encrypted data packets are sent.

In a further advantageous embodiment, the method steps carried out by the executing communication unit can be defined in an executable computer program product in various terminal devices. In this way in the desired terminal devices in which the computer program product (that generally is also called an “app”) is executable can be integrated spontaneously in an existing communication group or can be used to set up a new communication group. Only downloading and startup of the corresponding app is necessary.

The present invention further relates to a real-time audio communication system with a plurality of communication units, each of which has at least one communication interface for connecting to the data network and an audio output, wherein at least one of the communication units is designed for executing the above method according to the invention. Such an audio communication system can be provided either in whole or in part by a supplier or the owners of suitable hardware (a simple Smartphone basically suffices) can integrate them in existing or new systems by downloading the corresponding program. Here any combination of professional equipment and “private” devices, for example Smartphones of individual users is possible.

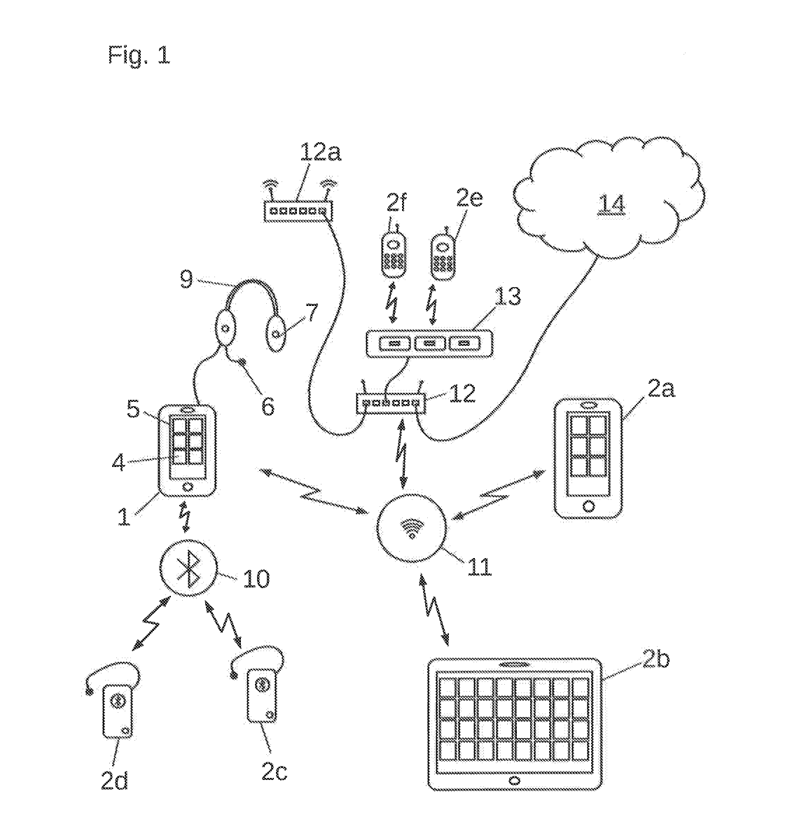

The present invention is described more closely below with reference to FIGS. 1 to 6, which show advantageous embodiments of the invention as examples, schematically and nonrestrictively. Wherein:

FIG. 1 shows a schematic representation of a number of devices of an audio communication system according to the invention;

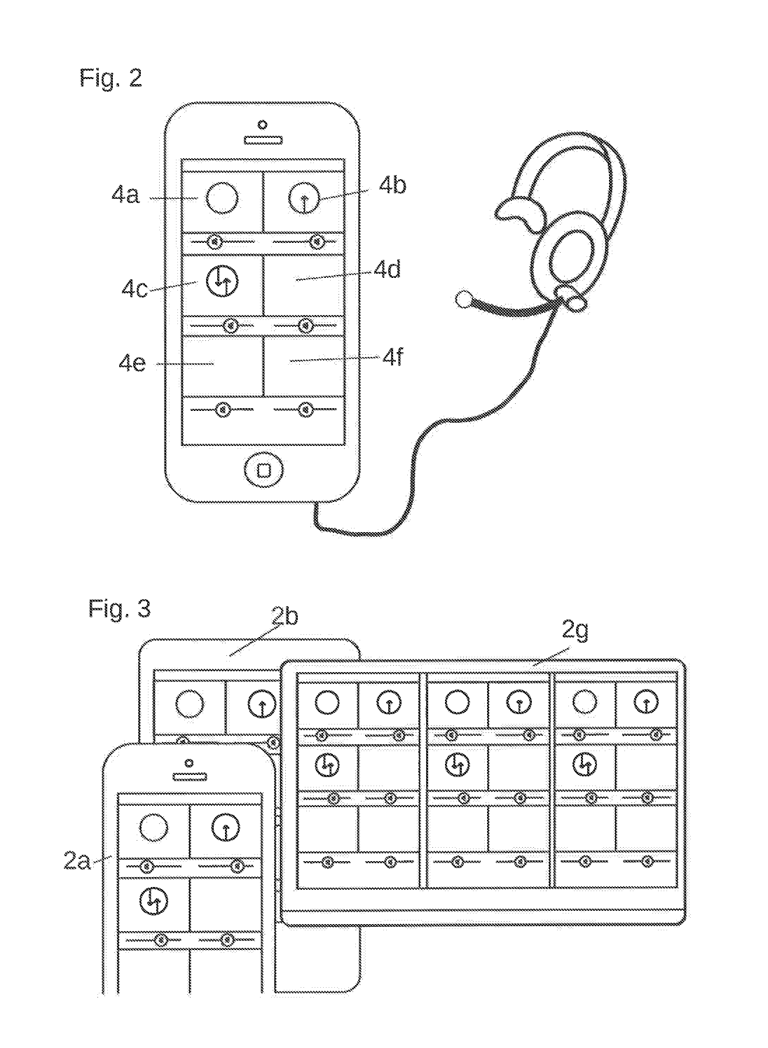

FIG. 2 shows an exemplary embodiment of the user interface of a communication unit;

FIG. 3 shows examples of use of various terminal devices of this communication unit;

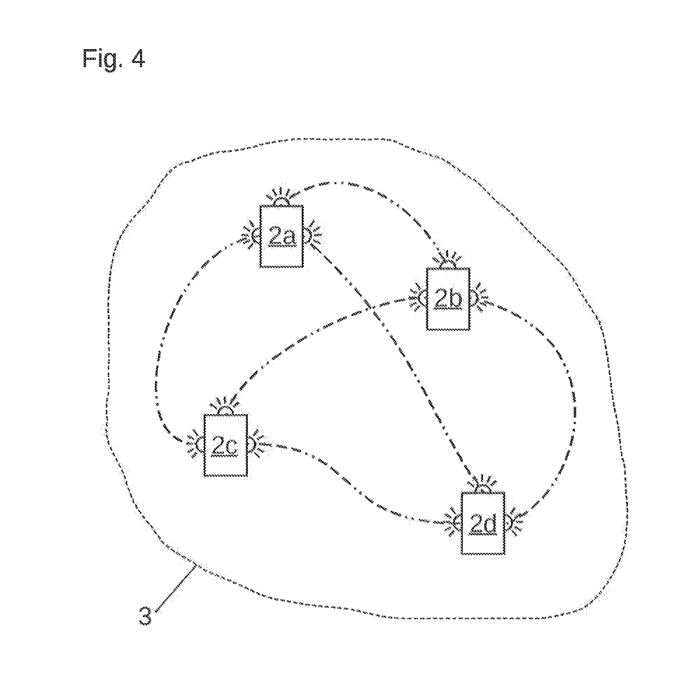

FIG. 4 shows a schematic representation of communication units for explaining the port-addressing in accordance with a preferred embodiment of the invention; and

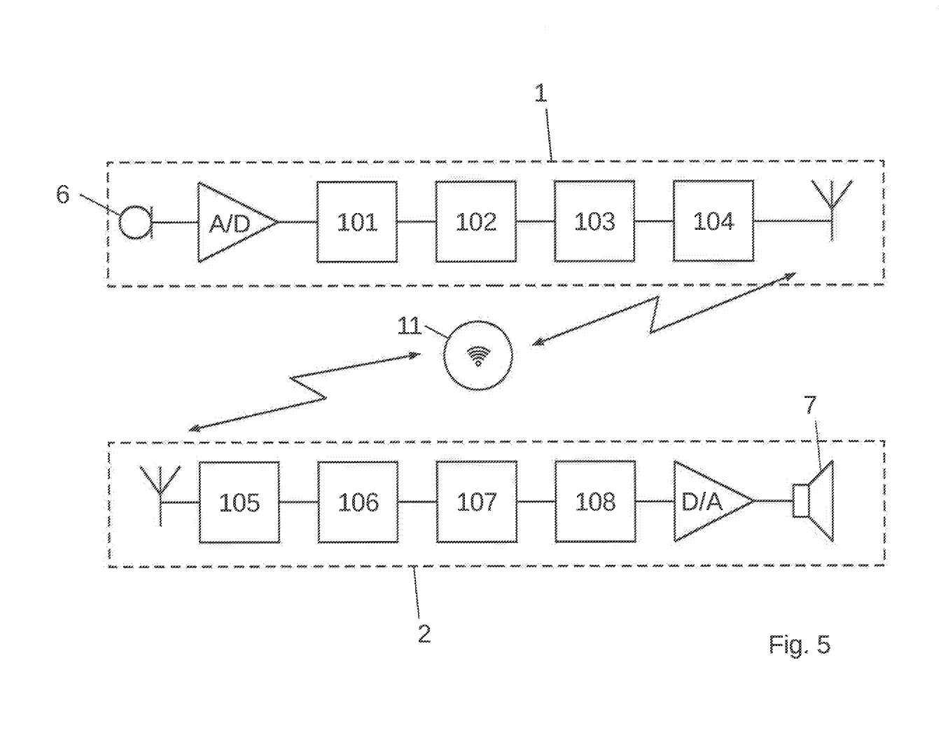

FIG. 5 shows a block diagram of a transmission link for illustration of measures that can be used for technical optimization in order to minimize the onset of delays during transmission.

Reference numerals of the elements that appear repeatedly in a figure are supplemented in each case by a lowercase letter to distinguish them more easily.

FIG. 1 shows an exemplary combination of several different devices that are combined in a real-time audio system according to the invention. The executing communication unit 1 is a normal Smartphone that has a touchscreen as the user interface 5. Several activation elements 4 are arranged on the user interface 5 that shall be described more closely below. A headset 9 is connected to the communication unit 1 and has a microphone 6 and earpiece that serve as the audio output 7. The headset 9 can also be connected wirelessly to the communication unit 1 as is usual and well-known in the field.

Furthermore, the communication unit 1 can be connected via a Bluetooth connection 10 to one or more Bluetooth headsets that are configured in the depicted case as further communication units 2c and 2d, and in each case are assigned to a different user. In an especially simple embodiment, a combination of one (or more) Smartphones that are connected to one another and possibly to a plurality of additional Bluetooth headsets is already sufficient to execute the method according to the invention that is described more closely below, in order to set up a real-time audio communication system according to the invention. Although such a network would be suitable only for very small areas and therefore be of limited utility, for example for group tours of museums or exhibitions or for setup of an “emergency operation” if other indication networks fail.

Preferably the executing communication unit 1 has a connection to a WLAN network 11 (shown in FIG. 1 only schematically as a symbol), so that communication with other devices in the network over the entire coverage area of the WLAN network 11 and possibly beyond that is possible. In FIG. 1 additional communication units include a further Smartphone 2a, a tablet PC 2b, several radios 2e, 3f, and the two already mentioned Bluetooth headsets 2c and 2d.

The additional Smartphone 2a can operate on the same or a different operating system from the Smartphone of the executing communication unit 1, wherein the difference between an “executing communication unit” and a “further communication unit” is solely dependent on the point of view. The distinction between the “executing” and the “further” communication unit serves only to explain and clearly define the invention and beyond that should not be understood as restrictive. Hence the Smartphone 2a shown in FIG. 1 as the “further communication unit” within the meaning of the invention can also be considered the executing communication unit, wherein in this case the Smartphone shown in FIG. 1 as the “executing communication unit 1” would be viewed as the further communication unit. This is no contradiction as the method according to the invention in a real-time communication system according to the invention in general is implemented by several communication units that then depending on the respective standpoint can't be viewed as the executing or the further communication units.

The same also applies to the tablets-PC 2b, which likewise can have any desired operating system in which an app is executable, which executes the method according to the invention on the tablet-PC. Both the tablet-PC 2b and the further Smartphone 2a have a touchscreen as the user interface on which the activation elements 4 can be provided.

A router 12 can also be provided in the WLAN network 11, which can have a connection to a remote network as for example the Internet 14 or possibly further networks. FIG. 1 shows a connection to a further router 12a for a WLAN-, WAN-, or LAN net, by which devices in the corresponding other networks can be integrated into the audio communication system according to the invention.

Furthermore, a radio station 13 is connected to the router 12 of FIG. 1, which radio station allows communication with a number of radio devices 2e, 3f, wherein the radio devices each can be viewed as further communication units 2, independently of whether they are suited to execute all functionalities of the method according to the invention or not. The radio station for example can be leased for the major event along with the radio devices as professional equipment, if for example it is necessary to extend the operating range of the data network beyond the radio range of the WLAN network. Thus for example with (sports) events over wide areas, continuous communication is possible. For example, the pit area in motorsports events or the start and finish areas of alpine sports can have a blanket WLAN system while the track points that are outside of the WLAN range can communicate via radio devices.

Furthermore, it would be possible to connect several WLAN bases, for example the directional radio links to one another, for example a mountain and a valley station in a skiing area. Due to the identical configuration of the WLAN, the devices used can automatically log into the respective WLAN (“Wi-Fi roaming”) and the connection of these two separate “bubbles” is implemented via the directional radio. In this way a large network is formed for the devices that are used, although the locations are far separated from one another.

Both in the professional area as well as the semiprofessional and amateur are numerous application options are conceivable for the audio communication system according to the invention. Without being limited to them, such application options would include sporting events, arts and cultural events, plant and enterprise communications, communications at industrial and commercial facilities, communication among participants of a group, for example tours, travel groups, leisure activities, crew communication or the like.

Many devices possess the capability of setting up ad-hoc WLAN. In this way for example a device can be designed with the method according to the invention and itself operate as a router and thus for example provide a mobile network that is used for communication. For example, a tour guide could set up the network with his device and provide the surrounding persons of the travel group access to the WLAN, through which then the communication connection could be set up.

The method, which can be used in setting up a real-time audio communication system according to the invention, is described below in detail with reference to an exemplary embodiment with reference to FIG. 2 in association with FIG. 1. FIG. 2 shows the executing communication unit 1, in the shown case a Smartphone with a headset 9 connected thereto, in a detailed depiction. The use of a headset constitutes a preferred embodiment, but a different combination of loudspeaker and microphone can also be used for the method according to the invention.

In order to set up a real-time audio communication system (or to add the Smartphone 12 and existing system), the app provided for the corresponding operating system is downloaded and started. Depending on the operating settings, now a selection can be made about which networks will be used to set up the communication system, wherein in a basic setting the WLAN network is used as the default value, to which the Smartphone is connected.

The app now scans the network for further communication units with which an audio connection can be established and presents them for selection to the user, who can combine them into a communication group (or all available devices are automatically combined into a group). This scan process can for example be carried out over a general open port that is used uniformly by all devices for communication during the connection setup. Possibly further devices that are not recognizable via the scanning function can be added via the corresponding queries. This can be necessary for example if further communication units are located outside of the same WLAN network or if devices are to be added as further communication units that themselves do not execute the method according to the invention (for example use the corresponding app), but are pure terminal devices as is the case for example for the radio devices 2e and 2f or the Bluetooth headsets 2c and 2d in FIG. 1.

For the search process for example, in each device a free port can be opened. This is subsequently sent (“advertised”) to a special IP address. This address is a so-called broadcast address, which further distributes this packet to the remaining clients in the network. The other devices at the same time run a program that specifically searches for the advertised service, wherein the output packets are filtered and analyzed, and in this way can find the other devices. This process proceeds independently of the addressing, as names are used. Only afterwards is the respective IP address obtained (this can also change at any time). Subsequently then the direct connections between the devices are established.

To facilitate the selection of the communication group, which is always defined for the executing communication unit, any user interfaces, list representations, or queries can be used. For the formation and programming of suitable user interfaces, countless possibilities are known in the professional area.

In a preferred embodiment, for selection of the communication group a graphical user interface is used that substantially corresponds to the user interface shown in FIG. 2, wherein the elements for the selection process and the formation of the communication group can be formed differently in order to distinguish them from the user interface during operation. Activation elements for further communication units that are indeed available but cannot yet be attached to the communication group can for example be marked by their own color or shape, for example a pale color, gray tones, or they can differ with respect to size or shape.

It is furthermore possible to use predefined groups or to take over in their entirety groups that were already defined in a further communication unit. The selection of the communication group can thereby be concluded in a very short time.

In FIG. 2 the user interface 5 is depicted on the touchscreen of the Smartphone as it could look after the selection of the communication group 3 during operation of the communication system. On the user interface 5 there are several activation elements 4a, 4b, 4c, 4d, 4e, and 4f arranged in the form of individual rectangles. Each activation element can be assigned to a further communication unit or to a subgroup of communication units, wherein in the depicted case the activation element 4a is assigned to the Smartphone 2a (FIG. 1), activation element 4b to the tablet-PC 2b, and activation element 4c to the Bluetooth headset 2c. In the present case no communication unit is assigned to the activation elements 4d, 4e, and 4f. Thus the communication units 2a, 2b, and 2d (FIG. 1) that are assigned to the activation elements 4a, 4b, and 4c, together with the executing communication unit 1, form the communication group 3 as is defined for the communication unit 1. Furthermore, its own volume control 8 is assigned to each activation element, by which the volume of the respective audio channel is adjustable.

In a real-time audio communication system according to the invention in which several communication units execute the method according to the invention in parallel, it is not necessary that the communication groups 3 be identical for each unit, even if this can be the case in many instances. The communication group is always defined for the respective executing communication unit and can be expanded or restricted for the latter as desired. Since no central server is necessary, it is also not necessary to centrally define the individual communication groups 3.

Nonetheless, a preset definition of the executing communication units can be used if this is advantageous for the respective application. The definitions could then for example be provided on a server for downloading, wherein the server is not involved in execution of the communication method. Above all, for larger and more complex communication systems a pre-definition can significantly simplify and expedite the system set-up.

As soon as a further communication unit is added to the communication group, via the data network a connection to this further communication unit is set up wherein addressing is used that preferably remains subsequently unchanged. Advantageously an assigned port can be defined by the executing communication unit for each further communication unit in the group, which port is reserved exclusively for communication with this further communication unit, wherein the further communication unit likewise can reserve its own port for the executing communication unit. FIG. 4 shows schematically as an example a network for an audio communication system with four communication units (2a, 2b, 2c, 2d), each of which is operated as executing communication units and forms a communication group 3. Each of the communication units has three ports defined, wherein each port is precisely assigned to another port of a further communication unit. The ports remain constantly open so that after the communication system is built, new addressing is no longer necessary.

Basically it suffices if each communication unit stays open for the audio communication of two ports (one for transmission and one for reception). With two partners therefore two ports can be open per device for audio data (transmission, reception) and two ports (transmission, reception) for control data (requesting authorization, queries about whether the partner is still available, etc.).

It would also be possible to keep fewer ports open and to regulate the appropriate addressing oneself via a specific format in the data packets. The precise implementation can be effected according to personal preference of the respective developer.

Once again referencing FIG. 2, the use of a user interface 5 of an executing communication unit 1 in a real-time audio communication system is described in detail. Each activation element is marked by a combination of color, pattern, labeling, and graphic design so that the specific status of the communication channel is quickly identifiable. In FIG. 2 for example the activation element 4a is provided with a circular icon which indicates that the audio channel to the communication unit connected to the activation elements 4a is in standby status (that is, the audio channel is available but at present is closed). For more rapid recognition of the icon, a specific color can also be assigned to it, for example all activation elements on standby can have a blue color.

The audio channel to a communication unit can be opened by activation of the corresponding activation element, wherein several activation types can be provided. For example, all activation elements can be opened by means of a “push-to-talk” function quickly by touching the activation elements, wherein the connection is again closed as soon as the touch is released. It is also possible to press several activation elements at the same time with a number of fingers, wherein then all of the corresponding voice channels are opened simultaneously. In FIG. 2 the activation element 4b for identifying push-to-talk operation shows a round icon with a simple arrow, wherein the icon can be assigned a green color. This marking can be use both when the push-to-talk operation itself is activated (active push-to-talk) and when a different device has opened an audio channel to one's own device via the push-to-talk function (passive push-to-talk). It is therefore always quickly discernible which participant is speaking at the moment.

It is also possible that both partners start an active push-to-talk at substantially the same time (simultaneous push-to-talk). In this case a two-way audio communication is set up until one of the communication partners releases the touch. Then the status alternates in passive push-to-talk or standby.

In order to permanently open an audio channel, this can for example be double pushed, wherein it changes its color for example to red and shows the icon of the activation element 4c with a red cross and two arrows. Using the color and the icon the user can quickly determine at any time which of the audio channels is open at the moment. In order to mark the channels, each activation element is labeled, wherein preferably the name and possibly the position of the respective interlocutor can be indicated. If necessary also a picture or an avatar of the interlocutor can be shown.

Depending on need and the established authorizations, activation of a long-term audio channel (activation element 4c) can be effected immediately after selection or it can require confirmation by the interlocutor, wherein in this case the activation element for example can be displayed in alternating blinking colors, as long as the connection is not confirmed. In the opposite case, an activation element can begin blinking when there is an incoming activation query until the query is confirmed by touching the icon. Incoming activation queries, just as other events, can also be indicated by an acoustic signal. If applicable the query can also be dismissed for example by double touch of the activation element.

The activation elements 4d-4f, which in FIG. 3 are assigned to no communication unit, can if necessary subsequently be assigned to one by selection of a further communication unit. It is furthermore possible to provide a subgroup of several communication units of the communication group, which then can be assigned to a single activation element, for example the activation elements 4e of FIG. 2. All communication units that are combined in a subgroup can be simultaneously activated or deactivated with the one activation element. For example, this could be used in order to address all track marshals, all camera people, or all security personnel etc. at the same time. It can be selected whether for a communication unit that is assigned to a subgroup, another activation element should also be used or not. An individual further communication unit can also be assigned to several groups simultaneously.

FIG. 3 for example shows three different devices that can be used as communication units, namely a Smartphone 2a, a tablet-PC 2b, and a laptop PC 2g. The different size of the display makes it possible on larger devices to display a larger number of activation elements, whereby in some cases with the corresponding computers, even very large monitors can be used in order to be able to graphically display facilities with numerous voice stations or subunits. Such an embodiment could assume the functionality of a communication center. FIG. 3 shows that the simple and clean design of the tile-like activation elements is readily scalable to different display sizes without loss of clarity.

It is also possible to integrate devices with limited functionality into the communication group. For example, specific persons can be supplied with a simplified communication unit that has no touchscreen user interface but only a limited selection of predefined activation elements or a single activating button to activate a predefined voice connection to a predefined executing communication unit. It would also be possible for those devices that do not possess the full functionality of the method according to the invention, to use them entirely without activation elements, wherein in this case a voice control can be used in order to identify when exactly the user is speaking and then to open the audio connection. Such a system could be used for example for camera people or other people who do not have a hand free to operate an additional user interface.

In alternative embodiments of the invention, possibly further operating modes can be provided wherein below some of the operating modes and their designations are listed by way of example.

“Symbol the Voice” (STV): images can be assigned to activation elements (personal photos, symbols for groups/single person, avatars).

“Auto Voice Mode”: voice activation (transmission only during speaking).

“Add My Voice” (AMV): One's own voice is reproduced as a side channel over one's own headset. The voice is preferably played back only when an active/simultaneous push-to-talk or a permanent connection is present (and the microphone is not set to mute).

“Machine Voice Mode” (MVM): For specific events, an audio feedback can be generated and played back by means of voice synthesis (when your cell phone is in your pocket, for example).

“2 Channel” (2 CM): Panning functionality wherein persons or audio channels are apportioned to the left or right ear. Using a surround system, several channels (for example right—left—center) would also be feasible, wherein an even larger number could be made possible by using a surround headset system.

“Auto Recovery Mode” (ARM): possibility of status restoration, for example in a program crash to re-enter. The connections are automatically restored.

“Other Voice Occupied” (OVO): The status of a further communication unit is shown on the activation element (when for example the interlocutor received a call with the mobile telephone that is serving as the communication unit, this is displayed to the communication partners on their devices).

“Wi-Fi Field Monitor” (WFM): Not only the field intensity of the WLAN can be shown, but also the present stability that can influence the quality of the real-time transmission.

“Voice Monitor Mode” (VMM): person currently speaking is indicated by symbol.

“Bundle Voice Mode” (BVM): this function corresponds to the describe formation of subgroups.

“Secure Chat Mode” (SVM): The signals are transmitted in encrypted form.

“External Control Mode” (ECM): Functions of the app can be run by headset control (that is, via the control elements provided on the headset). For this purpose for example the louder and softer buttons can be set with alternative functions.

“Call Last Voice” (CLV): An activation element serves for call-back to the last activated interlocutor in order to quickly answer this person without having to look for the corresponding activation element for the corresponding channel.

“Line to ALL” (LTA): All audio channels are opened simultaneously for a group call (voice connection to all).

“LineApp Over Internet” (LOI): Several WLAN islands can be connected via the Internet.

“Stay Connected Mode” (SCM): When the WLAN net is dropped, there is automatic change to an alternative network, preferably a network of mobile telephone suppliers. The necessary addressing data (and thus for example telephone numbers of the further communication units) can be stored during the initial connection setup together with the other addressing data of the further communication units.

“Locate Voice Mode” (LVM): The location of a just transmitting device is detected by GPS and can be depicted on a plan (for example a map, a city plan, a building plan, or a schematic location representation).

“Welcome Voice Procedure” (WVP): With first opening of the application, a voice-supported introduction is provided through the installation phase.

By means of optional offering of the different operating modes, the method according to the invention can be adapted to various user groups and different price categories. FIG. 5 shows for example a transmission link from a microphone 6 of a first executing communication unit 1 to a loudspeaker 7 of a further communication unit 2. The analog signal recorded from the microphone 6 is converted in an analog-digital converter A/D into a digital data stream, which is transmitted to a raw digital audio processor 101. Since the transmission of digital data requires considerably less time than the corresponding receiving duration, the data from the A/D converter is buffered and sent at regular intervals to the raw data audio processor 101. This buffering even during digitizing of the audio signal leads to a delay of the audio signal that can be minimized by suitable parameter selection.

The raw digital audio processor 101 converts the digital data stream into a digital raw audio format that can be further processed according to a specific codec. The coding according to the codec takes place in an encoder 102, by which the coded data stream can be converted in packet preparation 103 into audio data packets. The steps of coding and packet preparation 103 are significant for the overall delay of the transmission, as the selected size of the audio data packets directly affects the delay. The audio data packets provided by packet preparation 103 can be formulated according to one's own internal standard, which also can have data for an error correction as for example overlapping data regions with the adjacent audio data packets. Here prognostic data regarding the quality to be expected of the subsequent data transmission are already taken into consideration.

While the A/D converter and the raw digital audio processor 101 frequently are dependent on the hardware or on an operating system of the executing communication unit 1, and permit only a limited measure of influence, the functional mode of the encoder 102 and packet preparation 103 in implementation of the method according to the invention can be formed and optimized as desired by means of the corresponding programming.

The audio data packets are sent from packet preparation 103 to a network module 104, wherein preferably this is the network module contained in the executing communication unit 1. The network module 104 handles in a conventional manner the packet-mediated transmission via the WLAN network 11 (or some other net), wherein for example the UDP-protocol can be used. Here the audio data packets supplied by packet preparation are “packed” into the transmission of data packets suitable for the respective transmission protocol and are sent in conventional manner via the WLAN network 11. Overloading of the network, poor ambient conditions, or inadequate hardware can lead to significant delays, however. These delays can on the one hand be minimized by using suitable hardware, or on the other hand the transmission of data packets can be marked for the audio transmission with a real-time flag, by means of which delays are largely avoided, as routers prioritize transmission data packets marked in that way. This presupposes that the router that is used recognizes real-time flags and can process them.

Instead of the depicted local WLAN network 11, transmission can also be implemented via other links, for example an internal wide-area network or via the Internet. In such cases however additional delays can arise that are outside of the influence of the system operator.

Care must therefore be taken that communication is always over the shortest possible path, wherein this is possible according to the invention as the entire communication infrastructure manages without servers and therefore can be designed with maximal flexibility. Depending on the available infrastructure and the audio connection that has to be activated in each case, the system can thus preferably select a direct connection (from antenna to antenna). If this is not possible, the system selects a connection via one or more routers of the WLAN network 11. Only when this too is not possible, a different connection for example a wide-area network or the Internet is selected. FIG. 1 shows for clarity's sake only the WLAN network 11 as an example.

The transmission data packets are sent via the WLAN network 11 to the further communication unit 2 and are there processed by its network module 105. From the network module 105 the received transmission data packets are again converted into audio data packets and go to a jitterbuffer 106 and from there on to a decoder 107, a raw audio digital processor 108, and a digital/analog converter D/A, and are then output as an analog audio signal via the loudspeaker 6.

In the further communication unit 2, which in the shown case acts as a receiver of the audio signal, in particular the functions of the jitterbuffer 106 and the decoder can largely be freely formed using software, but also the functionality of the network module 105, the raw audio digital processor 108, and the digital/analog converter D/A can be influenced to minimize the transmission delay by means of programming. At the jitterbuffer 106, the buffering time has to be minimized, wherein preferably an adaptive jitterbuffer is used. The adaptive jitterbuffer makes it possible to always adjust the buffering time to the transmission quality and to minimize it accordingly such that quality audio transmission is always possible as long as this is permitted by the transmission quality of the network. Optimization is here adjusted to the function of the decoder 107 such that error correction processes (for example FEC or PLC) operate optimally and can compensate a data loss. In order to be able to optimally adjust the function of the jitterbuffer 106 and the decoder 107 to the respective predominant transmission conditions, the packet loss that is to be expected can be continuously tested via a data line so that the jitterbuffer 106 even at the start of the audio transmission can proceed with an optimized value for the buffering time.

In general, the function of the jitterbuffer (as well as the other elements of the transmission link) can be optimized such that priority is conceded to minimization of the audio delay in comparison with the audio quality. When the transmission conditions are poor this can mean that the speech is received by the recipient without a noticeable delay but is no longer clearly understood. In this case the user can be provided with a functionality by which he can switch over for a time to higher audio quality (at the expense of audio delay).

1. A method for providing selectable real time audio connections in which the audio connection has a delay of less than 40 ms, preferably less than 20 ms between an executing communication unit and a plurality of further communication units in a communication group, wherein at least the executing communication unit provides a plurality of activation elements which can be activated by user selection for selective activation of real time audio connections between the executing communication unit and at least one further communication unit associated with the respective activation element, and wherein the executing communication unit executes the following steps:
establishing a connection to a data network;
determining further communication units which are located in the range of the data network and which are capable of establishing a real time audio connection;
forming a communication group which comprises the executing communication unit and at least one of the determined further communication units;
defining an address assignment for an audio channel via the data network to the at least one remote communication unit;
providing an activation element, which is assigned at least to the one remote communication unit, on a user interface of the executing communication unit;
receiving a user input for activation of the audio channel by selecting the activating element; and
opening the audio channel via the data network using the address assignment and keeping the audio channel open as long as the activation element is activated.

2. The method according to claim 1, wherein the communication group is defined for the respective executing communication unit.

3. The method according to claim 1, wherein the method sets up an intercom system in which the entire communication can take place via a data network without the interposition of a server.

4. The method according to claim 1, wherein the opening of the audio channel takes place immediately upon activation of the real time audio transmission.

5. The method according to claim 1, wherein the address assignment exclusively contains allocated ports.

6. The method according to claim 1, wherein that activation elements for different types of activation can be activated, comprising any combination of an active, passive, one-way and/or two-way audio communication, wherein the current type of activation and/or the current status of the communication connection is indicated by a different configuration of the activation element.

7. The method according to claim 1, wherein all communication units determined in the data network are automatically combined into the communication group.

8. The method according to claim 1, wherein the step of forming a communication group includes defining sub-groups and/or allocating entitlements.

9. The method according to claim 8, wherein at least one activation element is simultaneously provided for activation of a plurality of further communication units.

10. The method according to claim 1, wherein a communication connection can be activated in addition to the transmission of data.

11. The method according to claim 1, wherein the communication connection has voice activation.

12. The method according to claim 1, wherein the executing communication unit and/or the remote communication unit is a stationary or mobile user device, and in particular is selected from smartphones, mobile telephones, wireless devices, wireless headsets, tablet PCs, personal computers, pagers capable of audio communication, devices designed specifically for the method or similar equipment.

13. The method according to claim 1, wherein the audio transmission is encrypted.

14. The method according to claim 1, wherein the method steps executed by the executing communication unit are defined in a computer program product which can run on different terminals.

15. A real time audio communication system with a plurality of communication units which in each case have at least one communications interface for connection to the data network and an audio output, wherein at least one of the communication units is designed for carrying out a method according to claim 1.
